(19) United States
(12) Patent Application Publication
(10) Pub. No.: US 2016/0264602 A1
(43) Pub. Date: Sep. 15, 2016

(54) MANUFACTURING METHOD OF SILATRANE WITH THIOL GROUP AND PRESERVATION METHOD THEREOF

(71) Applicant: NATIONAL CHUNG CHENG UNIVERSITY, Chia-Yi (TW)

(72) Inventors: Wen-Hao CHEN, New Taipei City (TW); Lai-Kwan CHAU, Chiayi City (TW); Yen-Ta TSENG, New Taipei City (TW); Chao-Wen CHEN, Tainan City (TW)

(21) Appl. No.: 14/856,145

(22) Filed: Sep. 16, 2015

(30) Foreign Application Priority Data
Mar. 9, 2015 (TW) 104107701

(51) Int. Cl. C07F 7/18

(52) U.S. Cl. CPC C07F 7/1836

(57) ABSTRACT

A manufacturing method of silatrane with thiol group and a preservation method thereof are disclosed. (3-Mercaptopropyl)trimethoxysilane and triethanolamine are reacted for a pre-determined time at a pre-determined temperature under nitrogen atmosphere in presence or absence of catalyst, and then a recrystallization process is performed with a solvent to obtain silatrane with thiol group of formula (1). Silatrane with thiol group is dissolved in an organic solvent to preserve the silatrane with thiol group.

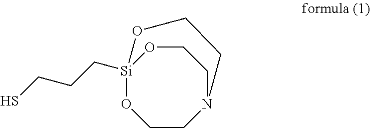 [SMILES: SCCC[Si]12OCCN(CCO1)CCO2]

### CROSS-REFERENCE TO RELATED APPLICATION

This application claims priority from Taiwan Patent Application No. 104107701, filed on Mar. 9, 2015, in the Taiwan Intellectual Property Office, the content of which are hereby incorporated by reference in their entirety for all purposes.

### BACKGROUND OF THE INVENTION

1. Field of the Invention

The present invention relates to a manufacturing method of silatrane with thiol group and preservation method thereof, in particular with respect to a manufacturing method of silatrane with thiol group with high yield by reacting (3-mercaptopropyl)trimethoxysilane and triethanolamine in a condition with or without a catalyst and to a method of improving the preservation efficiency by dissolving the silatrane with thiol group in the organic solvent.

2. Description of the Related Art

The compounds usually used for surface modification are mostly R—SiCl₃ or R—Si(OR)₃ (R comprises carbon chain and particular functional group), and the modification reaction mainly comprises performing a condensation reaction of hydroxyl group of the substrate and silane and then fixing it on the surface of the substrate (referring to FIG. 1). However, because chloro group (Cl) or alkoxy group is reactive, it is inconvenient to be preserved and used. Generally, the surface modification molecules containing chloro group (R—SiCl₃) can be used to modify the surface of the substrate at concentration of about 1 mM, but they are not widely used due to high activity with moisture. The concentration of the surface modification molecules containing alkoxy group such as (3-mercaptopropyl) trimethoxysilane (MPTMS) must be raised to 2-5% (about 120-250 mM) and also takes a long time so as to accomplish the modification well, but using high concentration of the molecules and long modification time is not cost-effective.

In recent years, scientists have developed another more stable silane derivative called silatrane, which is more stable than traditional silane under ambient conditions, and is more suitable for surface modification. However, although the stability of silatrane is better than that of chloro and alkoxy silanes under ambient conditions, when silatrane in form of solid or gel contacts with moisture for long term, the hydrolysis and condensation reactions may occur due to the interaction of neighboring silatrane molecules, and will gradually lead to a stability problem. Therefore, the problem of preservation must be overcome during manufacturing.

### SUMMARY OF THE INVENTION

In view of the aforementioned technical problems of the prior art, one purpose of the present invention is to provide a method of manufacturing silatrane with thiol group so as to improve the yield of silatrane with thiol group.

Further, another purpose of the present invention is to provide a method of preserving silatrane with thiol group such that silatrane can be preserved for a long time.

In order to accomplish the preceding purpose, the present invention provides a method of manufacturing silatrane with thiol group, comprising: reacting (3-mercaptopropyl)trimethoxysilane and triethanolamine for a pre-determined time at a pre-determined temperature and a fixed stirring rate under nitrogen atmosphere in presence or in absence of a catalyst; and performing a recrystallization process by using a solvent to obtain the silatrane with thiol group of formula (1)

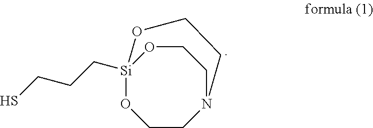 [SMILES: SCCC[Si]12OCCN(CCO1)CCO2]

In an embodiment of the present invention, if the catalyst is not used, the pre-determined temperature is within the range of 150-200° C., and 180° C. is preferred; a stirring rate is within the range of 200-1000 RPMs, and 600 RPM is preferred; and the pre-determined time is within the range of 2-6 hours, and 2 hours is preferred. And, after cooling to room temperature, the crystallization purification process is immediately performed.

In an embodiment of the present invention, if the catalyst is not used, the pre-determined temperature is within the range of 80-110° C., and 80° C. is preferred; the stirring rate is within the range of 900-1100 RPMs; and the pre-determined time is within the range of 12-44 hours, and 12 hours is preferred. And, after cooling to room temperature, the immediate product is filtered through sodium phosphate and the crystallization purification process is immediately performed.

In an embodiment of the present invention, if the catalyst is used, the catalyst is sodium phosphate or sodium hydrogen phosphate.

In an embodiment of the present invention, if the catalyst is sodium phosphate, the pre-determined temperature is within the range of 60-80° C., and the pre-determined time is within the range of 4-6 hours, wherein 80° C. and 4 hours is preferred.

In an embodiment of the present invention, if the catalyst is sodium hydrogen phosphate, the pre-determined temperature is room temperature, and the pre-determined time is within the range of 60-120 hours, wherein 100 hours is preferred.

In an embodiment of the present invention, the solvent is a mixed solvent of dichloromethane and propane. And, in an embodiment of the present invention, the mixed solvent contains 25-90% dichloromethane, wherein 50% is preferred. And during the second crystallization process, the mixed solvent contains 40-90% dichloromethane, wherein 65% is preferred.

The present invention also provides a method of preserving silatrane with thiol group, comprising: dissolving the silatrane with thiol group of formula (1) in an organic solvent within 30 minutes

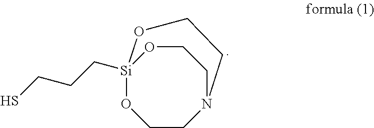 [SMILES: SCCC[Si]12OCCN(CCO1)CCO2]

In an embodiment of the present invention, the silatrane with thiol group is manufactured by the foregoing method.

In an embodiment of the present invention, the organic solvent is methanol, ethanol, tetrahydrofuran (THF) or dimethyl sulfoxide (DMSO).

In an embodiment of the present invention, the organic solvent is 20% dimethyl sulfoxide.

In accordance with the preceding description, a method of manufacturing silatrane with thiol group and preservation method thereof may have one or more following advantages:

(1) In the method of manufacturing silatrane with thiol group of the present invention, the yield of manufacturing silatrane with thiol group can be improved by reacting (3-mercaptopropyl)trimethoxysilane and triethanolamine in a condition with or without a catalyst.

(2) In the method of preserving silatrane with thiol group of the present invention, the preservation effectiveness can be improved by dissolving the silatrane with thiol group in the organic solvent.

### BRIEF DESCRIPTION OF THE DRAWINGS

FIG. 1 is a schematic diagram showing a condensation reaction of silatrane and hydroxyl group of the substrate, which is then fixed on the substrate.

FIG. 2 is a schematic diagram showing the reaction of manufacturing silatrane with thiol group of the present invention.

FIG. 3(a) is spectra resulting from self-assembly of gold nanoparticles on MPS-modified glass substrate under different preservation conditions and different preservation times (—: solid MPS preserving under atmospheric condition for 5 weeks; [symbol] : solid MPS preserving under nitrogen for 5 weeks; and [symbol] : MPS preserving in DMSO solvent under atmospheric condition for 1 year and 7 months); and FIG. 3(b) is spectra resulting from self-assembly of gold nanoparticles on MPS-modified glass substrate under different preservation conditions and different preservation times (—: solid MPS preserving under atmospheric condition for 3 weeks; and [symbol] : solid MPS preserving under nitrogen for 3 months).

FIGS. 4(a) and 4(b) are scanning electron microscopic images resulting from modification of MPS on the glass substrate and then performing self-assembly process with gold nanoparticles under different preservation conditions (FIG. 4(a): MPS preserving in DMSO solvent for 1 year; and FIG. 4(b): solid MPS preserving under atmospheric condition at 4° C. for 1 month).

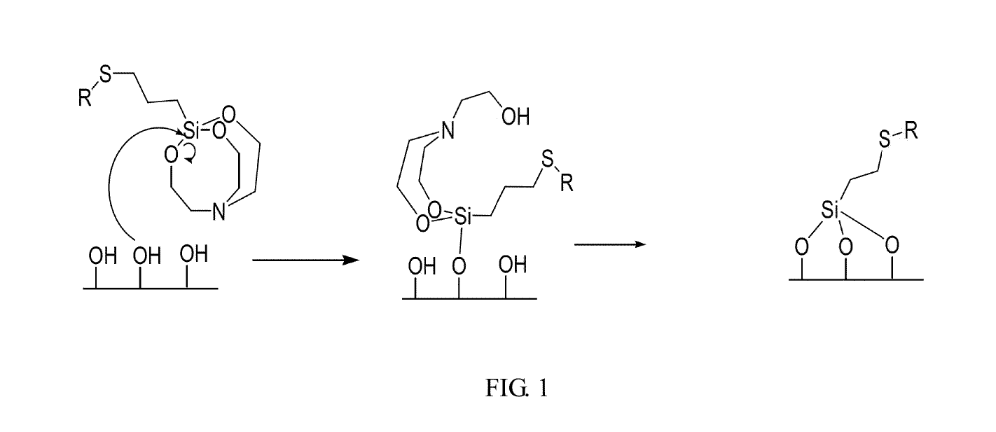

### DETAILED DESCRIPTION OF THE PREFERRED EMBODIMENTS

Thiol is a special functional group and capable of binding with most of noble metals via covalent bond. The combinations of adsorbate(s) bound on noble metals are listed in Table 1. Accordingly, the molecular structure of silatrane with thiol group as the specific functional group used for binding noble metal is chosen and shown as formula (2) below, wherein n is a positive integer from 0 to 11, for example, the number of carbon is three (n=2), which is named as (3-mercaptopropyl)silatrane (MPS). Unlike previous surface modification molecules, the modification effect is excellent when the concentration of MPS is 0.5 mM.

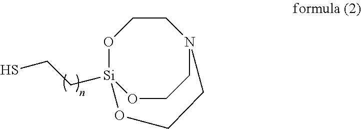

TABLE 1
Possible adsorbate(s) on surface of various substrates

| Surface | Substrate | Adsorbate(s) |
|---|---|---|
| Metal | Au | R—SH, R—SS—R, R—S—R, |
| | | R—NH₂, R—NC, R—Se, |
| | | R—Te |
| | Ag | R—COOH, R—SH |
| | Pt | R—NC, R—SH |
| | Pd | R—SH |
| | Cu | R—SH |
| | Hg | R—SH |
| Semiconductor | GaAs (III-V) | R—SH |
| | InP (III-V) | R—SH |
| | CdSe (II-VI) | R—SH |
| | ZnSe (II-VI) | R—SH |
| Oxide | Al₂O₃ | R—COOH |
| | TiO₂ | R—COOH, R—PO₃H |
| | YBa₂Cu₃O₇₋₅ | R—NH₂ |
| | Ti—Ba—Ca—Cu—O | R—SH |
| | ITO | R—COOH, R—SH, R—Si(x)₃ |
| | SiO₂ | R—Si(x)₃ |

The surface modification of a substrate by MPS can be accomplished in one hour. The modification efficiency can be analyzed indirectly by using the absorption peak of the surface plasmon resonance of the gold nanoparticle. The aqueous phase gold nanoparticle solution used in the following examples is obtained by reducing tetrachloroauric salt with sodium citrate in water, and then the aqueous phase gold nanoparticles are self-assembled on the MPS-modified substrate.

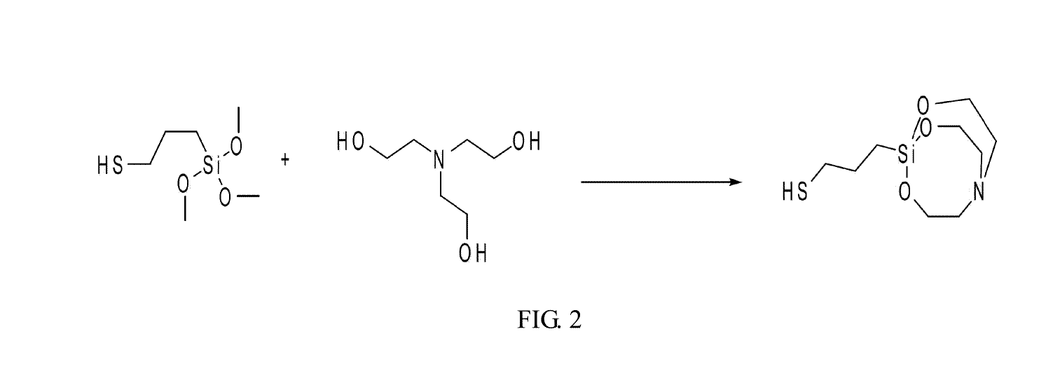

Referring to FIG. 2, which is a schematic diagram showing the reaction of manufacturing silatrane with thiol group of the present invention. As shown in FIG. 2, (3-mercaptopropyl)trimethoxysilane as the starting molecule and triethanolamine or the triethanolamine derivatives thereof are reacted at room temperature or higher temperature environment to obtain silatrane with thiol group. The examples of manufacturing silatrane with thiol group are illustrated below.

The method of manufacturing silatrane with thiol group can be listed as follows:

Method 1:

(3-Mercaptopropyl)trimethoxysilane (196 mg, 0.001 mol) and triethanolamine (135 mg, 0.009 mol) are added into a reaction flask, and then the mixture is heated to 180° C. for 2 hours and stirred with a stirring rate within the range of 600-800 RPMs. The immediate product is allowed to cool to room temperature after reaction, and the recrystallization process is preformed three times by using a mixed solvent of dichloromethane and propane (1:1) at low temperature (4° C.). The recrystallized product is characterized by nuclear magnetic resonance spectroscopy. The color of the product is brown with yield of 59%. The yield of the product will decrease to 26-35% if the amount of (3-mercaptopropyl)trimethoxysilane is increased to 19.6 g (0.1 mol).

Method 2:

(3-Mercaptopropyl)trimethoxysilane (196 mg, 0.001 mol) and triethanolamine (135 mg, 0.009 mol) are added into a reaction flask, and then the mixture is heated to 80-110° C. for 12-44 hours and stirred with a stirring rate within the range of 900-1100 RPMs, wherein reaction for 12 hours at 80° C. is preferred. The immediate product is allowed to cool to room temperature after reaction, and is filtered through sodium sulfate, and then the recrystallization process is performed three times by using a mixed solvent of dichloromethane and propane (1:1) at low temperature (4° C.). The recrystallized product is characterized by nuclear magnetic resonance spectroscopy. The color of the product is brown with yield of 65%. The yield of the product will decrease to 33-41% if the amount of (3-mercaptopropyl)trimethoxysilane is increased to 19.6 g (0.1 mol).

Method 3:

(3-Mercaptopropyl)trimethoxysilane (196 mg, 0.001 mol) and triethanolamine (135 mg, 0.009 mol) are added into a reaction flask, then 0.1 mole percent sodium phosphate (catalyst) is added and acetonitrile is further added, and then the mixture is heated to 60-80° C. for 4-6 hours under nitrogen atmosphere and stirred with a stirring rate within the range of 800-1000 RPMs, wherein reacting for 4 hours at 80° C. is preferred. The immediate product is allowed to cool to room temperature, and is filtered through sodium sulfate, and then the recrystallization process is performed three times by using a mixed solvent of dichloromethane and propane (1:1) at low temperature (4° C.). The recrystallized product is characterized by nuclear magnetic resonance spectroscopy. The color of the product is brown with yield of 55%. The yield of the product will decrease to 16-37% if the amount of (3-mercaptopropyl)trimethoxysilane is increased to 19.6 g (0.1 mol).

Method 4:

(3-Mercaptopropyl)trimethoxysilane (196 mg, 0.001 mol), triethanolamine (135 mg, 0.009 mol) and 0.1 mole percent sodium hydrogen phosphate (catalyst) are added into a reaction flask, and then the mixture is allowed to react for 60-120 hours at a stirring rate between 900-1150 RPMs under nitrogen atmosphere at room temperature, wherein reacting for 100 hours is preferred. After reaction, the recrystallization process is performed three times by using a mixed solvent of dichloromethane and propane (1:1) at low temperature (4° C.). The recrystallized product is characterized by nuclear magnetic resonance spectroscopy. The color of the product is white with yield of 75%. The yield of the product will decrease to 58-65% if the amount of (3-mercaptopropyl)trimethoxysilane is increased to 19.6 g (0.1 mol).

In the foregoing methods 1 and 2, silatrane with thiol group is synthesized at high temperature without adding catalyst, and the temperature is within the range of 80-200° C. and the stirring rate is within the range of 400-1100 RPMs and the reaction time is 2-44 hours. Method 1 is the best method, and the best reaction condition is reacting for 2 hours at 180° C. and 600 RPMs. The recrystallization process can be directly performed after finishing the reaction without performing filtering process.

In the foregoing methods 3 and 4, method 4 is the best method to synthesize silatrane with thiol group (adding weak alkaline inorganic salts as catalyst at room temperature, the concentration of the catalyst is within the range of 0.05-2% mol, and 0.1% is preferred) since it can be easily scaled up and the yield can also be improved. In method 4, the yield can be improved to 75% without carbonization of the sample at high temperature.

No matter what kind of foregoing method, the product must be dissolved in organic solvent within 30 minutes. The solubility of MPS in aqueous phase or organic phase solvents will decrease as time passes. The solubility of MPS in dimethyl sulfoxide (DMSO) is about 99% after 30 minutes, and the solubility is about 90% after 1 day, and the solubility is about 40% after 1 week.

Tests of Preserving Method

Performing the tests of three preserving methods that preserve MPS under atmospheric condition, under nitrogen and in organic solvent.

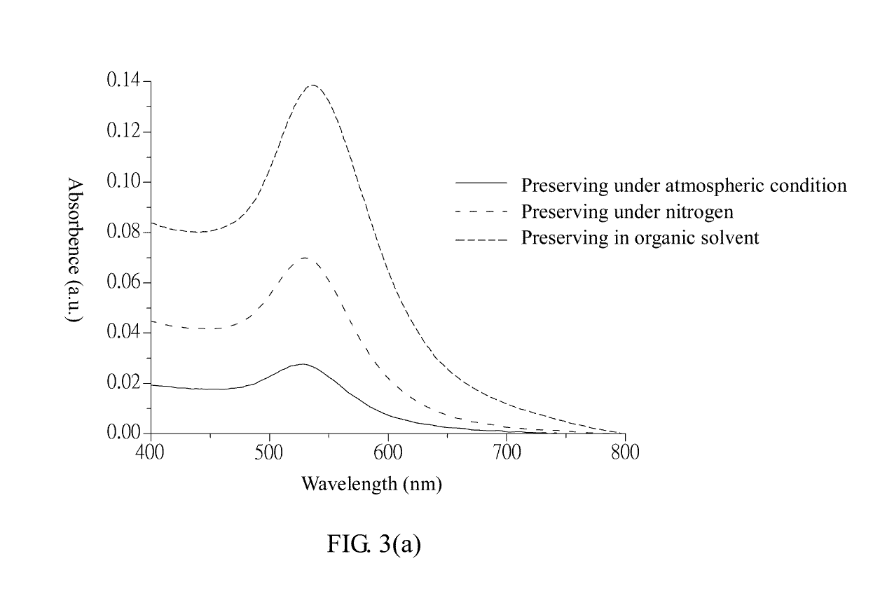

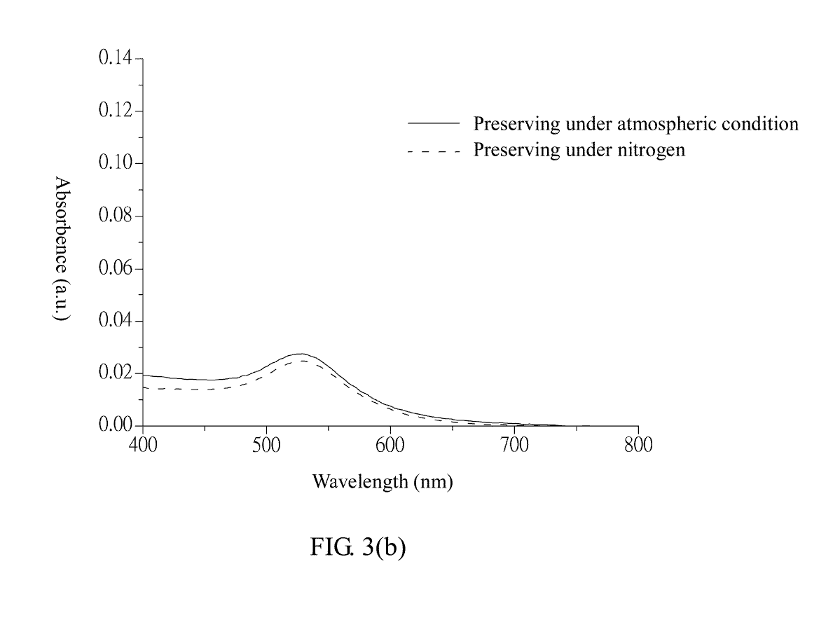

Referring to FIG. 3(a) and FIG. 3(b), FIG. 3(a) are spectra resulting from self-assembly of gold nanoparticles on MPS-modified glass substrate under different preservation conditions and different preservation times, and FIG. 3(b) are spectra resulting from self-assembly of gold nanoparticles on MPS-modified glass substrate under different preservation conditions and different preservation times.

Most silane molecules in general are placed in a brown bottle and stored at 4° C. To investigate the preservation conditions for MPS, the efficiency of the self-assembly reaction of gold nanoparticles on the MPS-modified substrate is used as an indirect indicator. There are two advantages by this approach. First, gold nanoparticles have a characteristic surface plasmon resonance band which can be easily observed in a visible light spectrum and its absorbance is related to the surface coverage of the nanoparticles modified on the surface of the substrate. Second, the peak width of the surface plasmon resonance band is related to the uniformity of the gold nanoparticles distributed on the surface of the substrate. In the present study, gold nanoparticles with 13 nm in diameter are chosen, and the characteristic absorption peak is about 530 nm. After synthesis, purified and dried MPS are separately stored under atmospheric condition at 4° C. and in a brown bottle at room temperature under nitrogen. As shown in FIG. 3(a), after 3 weeks, the sample preserved under atmospheric condition at 4° C. cannot be dissolved in any solvent, and the efficiency of self-assembly of gold nanoparticles on the MPS-modified surface starts to decrease. As shown in FIG. 3(b), after 5 weeks, the sample preserved under nitrogen cannot be dissolved and the efficiency of self-assembly of gold nanoparticles on the MPS-modified surface starts to decrease.

If the purified MPS is dissolved in organic solvent and then preserved under atmospheric condition and room temperature without avoiding light, the activity of the sample can be preserved for at least 1 year and 6 months (ex. 1 year and 7 months) (referring to FIG. 3(a)).

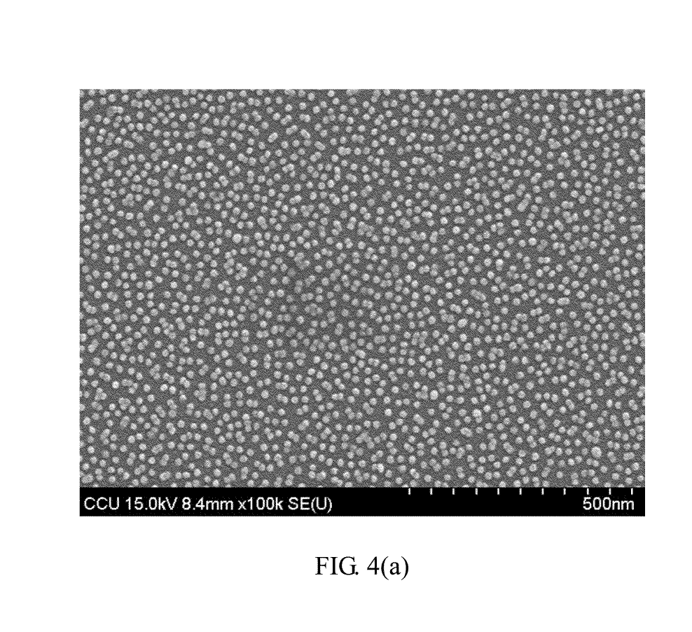

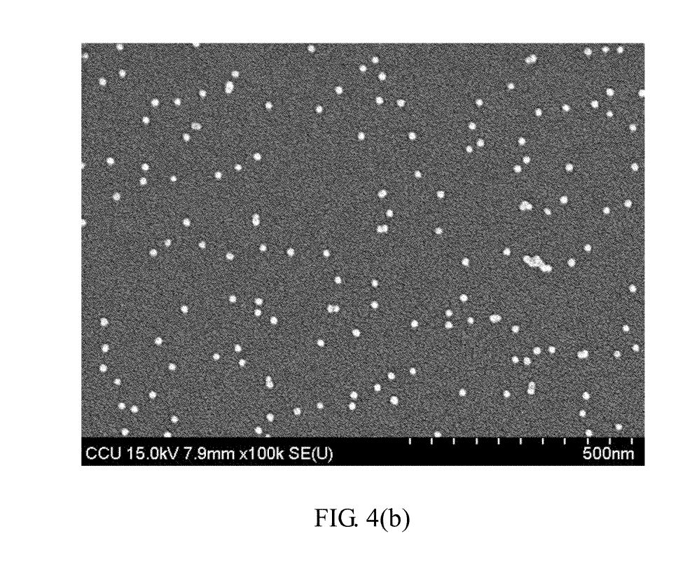

The activity of the sample is tested with the self-assembly reaction of gold nanoparticles on the surface of the substrate treated by the sample and then observed by visible light spectroscopy and scanning electron microscopy. The results are shown in FIG. 4(a) and FIG. 4(b) wherein, all experiments are performed by immersing the substrate in a methanol solution of MPS and then modifying gold nanoparticles on the treated substrate for 30 minutes.

It can be confirmed by the foregoing experiments that the activity of MPS cannot be maintained for a long time by preserving the purified and dried MPS at low temperature or under nitrogen. However, in the present invention, MPS is preserved in organic solvent, and the activity thereof can be extended to more than a year and six months. Wherein, the organic solvents are not limited to DMSO, commonly used organic solvents such as methanol, ethanol, tetrahydrofuran (THF) or dimethyl formamide (DMF) are able to maintain the activity of MPS. Additionally, it is not necessary to preserve MPS by using brown bottle to prevent light exposure. As an example in DMSO, the preserving concentration of DMSO is within the range from 0.01% to 40%, wherein 20% DMSO solution has the best preservation effect for MPS. Thus, costs and steps in preservation can be reduced, and the activity of MPS can also be maintained for a long time.

In summary, MPS can be preserved only for about two months by traditional nitrogen preservation method under dark condition, while MPS sample can be preserved over 1 year and 6 months by dissolving silatrane with thiol group in organic solvent and preserving under atmospheric condition and room temperature without avoiding light in the present invention. Therefore, loss of activity of MPS can be avoided by choosing organic solvent to preserve MPS, and with the improved synthetic method, the yield can be improved and the cost associated with manpower, material, and manufacturing time, and pollution of the environment can be reduced.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A method of manufacturing silatrane with thiol group, comprising:
reacting (3-mercaptopropyl)trimethoxysilane and triethanolamine for a pre-determined time at a pre-determined temperature under nitrogen atmosphere in presence or absence of a catalyst; and
performing a recrystallization process by using a solvent to obtain the silatrane with thiol group of formula (1)

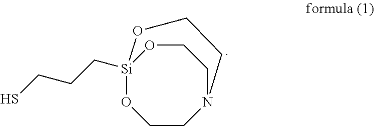 [SMILES: SCCC[Si]12OCCN(CCO1)CCO2]

2. The method of claim 1, wherein when the catalyst is absent, the pre-determined temperature is within the range of 150-200° C., and a stirring rate is within the range of 200-1000 RPMs, and the pre-determined time is within the range of 2-6 hours.

3. The method of claim 1, wherein when the catalyst is absent, the pre-determined temperature is within the range of 80-110° C., and a stirring rate is within the range of 900-1100 RPMs, and the pre-determined time is within the range of 12-44 hours.

4. The method of claim 1, wherein the catalyst is sodium phosphate or sodium hydrogen phosphate.

5. The method of claim 4, wherein the catalyst is sodium phosphate, and the pre-determined temperature is within the range of 60-80° C., and the pre-determined time is within the range of 4-6 hours.

6. The method of claim 4, wherein the catalyst is sodium hydrogen phosphate, and the pre-determined temperature is room temperature, and the pre-determined time is within the range of 60-120 hours.

7. The method of claim 1, wherein the solvent is a mixed solvent of dichloromethane and propane.

8. The method of claim 7, wherein the mixed solvent contains 25-90% of dichloromethane.

9. A method of preserving silatrane with thiol group, comprising:
dissolving the silatrane with thiol group of formula (1) in an organic solvent within 30 minutes

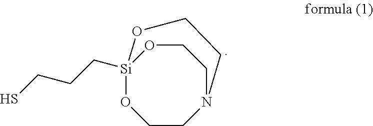 [SMILES: SCCC[Si]12OCCN(CCO1)CCO2]

10. The method of claim 9, wherein the silatrane with thiol group is manufactured by a method comprising:
reacting (3-mercaptopropyl)trimethoxysilane and triethanolamine for a pre-determined time at a pre-determined temperature under nitrogen atmosphere in presence or absence of a catalyst; and
performing a recrystallization process by using a solvent to obtain the silatrane with thiol group of formula (1).

11. The method of claim 9, wherein the organic solvent is methanol, ethanol, tetrahydrofuran or dimethyl sulfoxide.

12. The method of claim 11, wherein the organic solvent is 20% dimethyl sulfoxide.
